(19) United States
(12) Patent Application Publication
(10) Pub. No.: US 2018/0092115 A1
(43) Pub. Date: Mar. 29, 2018

(54) RELIABLE WI-FI PACKET DELIVERY USING DELAYED/SCHEDULED BLOCK ACKNOWLEDGMENT MECHANISM

(71) Applicant: QUALCOMM Incorporated, San Diego, CA (US)

(72) Inventors: Maksim KRASNYANSKIY, San Diego, CA (US); Hemanth SAMPATH, San Diego, CA (US); Sharad SAMBHWANI, San Diego, CA (US)

(21) Appl. No.: 15/713,531

(22) Filed: Sep. 22, 2017

Related U.S. Application Data
(60) Provisional application No. 62/401,791, filed on Sep. 29, 2016.

(51) Int. Cl. H04W 72/12; H04L 5/00

(52) U.S. Cl. CPC H04W 72/1257; H04W 72/0446; H04W 72/1231; H04L 5/0055

(57) ABSTRACT

A method, an apparatus, and a computer-readable medium for wireless communication are provided. In an aspect, an apparatus may be configured to transmit a first packet to a second wireless, the first packet comprising an ACK policy indicator within a MAC header of the first packet requesting a delayed ACK or a scheduled ACK in response to the first packet, to transmit a second packet to a second wireless, the second packet comprising a second ACK policy indicator within a second MAC header of the second packet requesting the delayed ACK or the scheduled ACK in response to the second packet, and to receive the delayed ACK or the scheduled ACK based on the first ACK policy indicator and the second ACK policy indicator.

### CROSS-REFERENCE TO RELATED APPLICATION(S)

This application claims the benefit of U.S. Provisional Application Ser. No. 62/401,791, entitled “RELIABLE WI-FI PACKET DELIVERY USING DELAYED/SCHEDULED BLOCK ACKNOWLEDGMENT MECHANISM” and filed on Sep. 29, 2016, which is expressly incorporated by reference herein in its entirety.

### BACKGROUND

### Field

The present disclosure relates generally to communication systems, and more particularly, to reliable Wi-Fi packet delivery using a delayed or scheduled block acknowledgment (ACK) mechanism.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

One aspect of this disclosure provides an apparatus (e.g., a wireless device) for wireless communication. The apparatus is configured to transmit a first packet to a second wireless. The first packet may include an ACK policy indicator within a medium access control (MAC) header of the first packet requesting a delayed ACK or a scheduled ACK in response to the first packet. The apparatus may be configured to transmit a second packet to a second wireless, and the second packet may include a second ACK policy indicator within a second MAC header of the second packet requesting the delayed ACK or the scheduled ACK in response to the second packet. The apparatus may be configured to receive the delayed ACK or the scheduled ACK based on the first ACK policy indicator and the second ACK policy indicator.

Another aspect of this disclosure provides an apparatus (e.g., a wireless device) for wireless communication. The apparatus is configured to receive a first packet from a second wireless. The first packet may include an ACK policy indicator within a MAC header of the first packet requesting a delayed ACK or a scheduled ACK in response to the first packet. The apparatus may be configured to receive a second packet to a second wireless. The second packet may include a second ACK policy indicator within a second MAC header of the second packet requesting the delayed ACK or the scheduled ACK in response to the second packet. The apparatus may be configured to determine a time to transmit a block ACK associated with (or acknowledging) the first packet and the second packet based on the first ACK policy indicator and the second ACK policy indicator. The apparatus may be configured to transmit the block ACK at the determined time.

### BRIEF DESCRIPTION OF THE DRAWINGS

FIG. 1 shows an example wireless communication system in which aspects of the present disclosure may be employed.

FIG. 2A illustrates exemplary diagrams of methods for controlling acknowledgment responses to frame transmissions.

FIG. 2B illustrates a conceptual model used by wireless communication devices.

FIG. 3 illustrates an exemplary diagram of a frame with an ACK policy indicator.

FIG. 4 is a functional block diagram of a wireless device that may be employed within the wireless communication system of FIG. 1.

FIG. 5 is a flowchart of an exemplary method of wireless communication for controlling acknowledgment frames.

FIG. 6 is a functional block diagram of an exemplary wireless communication device that controls acknowledgment frames.

FIG. 7 is a functional block diagram of a wireless device that may be employed within the wireless communication system of FIG. 1.

FIG. 8 is a flowchart of an example method of wireless communication for controlling acknowledgment frames.

FIG. 9 is a functional block diagram of an exemplary wireless communication device.

### DETAILED DESCRIPTION

Various systems, apparatuses, computer program products, and methods according to aspects of the invention are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of certain aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the aspects. The detailed description and drawings are merely illustrative of the disclosure rather than limiting, the scope of the disclosure being defined by the appended claims and equivalents thereof.

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An AP may also include, be implemented as, or known as a NodeB, Radio Network Controller (RNC), eNodeB, Base Station Controller (BSC), Base Transceiver Station (BTS), Base Station (BS), Transceiver Function (TF), Radio Router, Radio Transceiver, connection point, or some other terminology.

A STA may also include, be implemented as, or known as an access terminal (AT), a subscriber station, a subscriber unit, a mobile station, a remote station, a remote terminal, a user terminal, a user agent, a user device, a user equipment, or some other terminology. In some implementations, a STA may include a cellular telephone, a cordless telephone, a Session Initiation Protocol (SIP) phone, a wireless local loop (WLL) station, a personal digital assistant (PDA), a handheld device having wireless connection capability, or some other suitable processing device coupled to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, MIMO schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams, and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

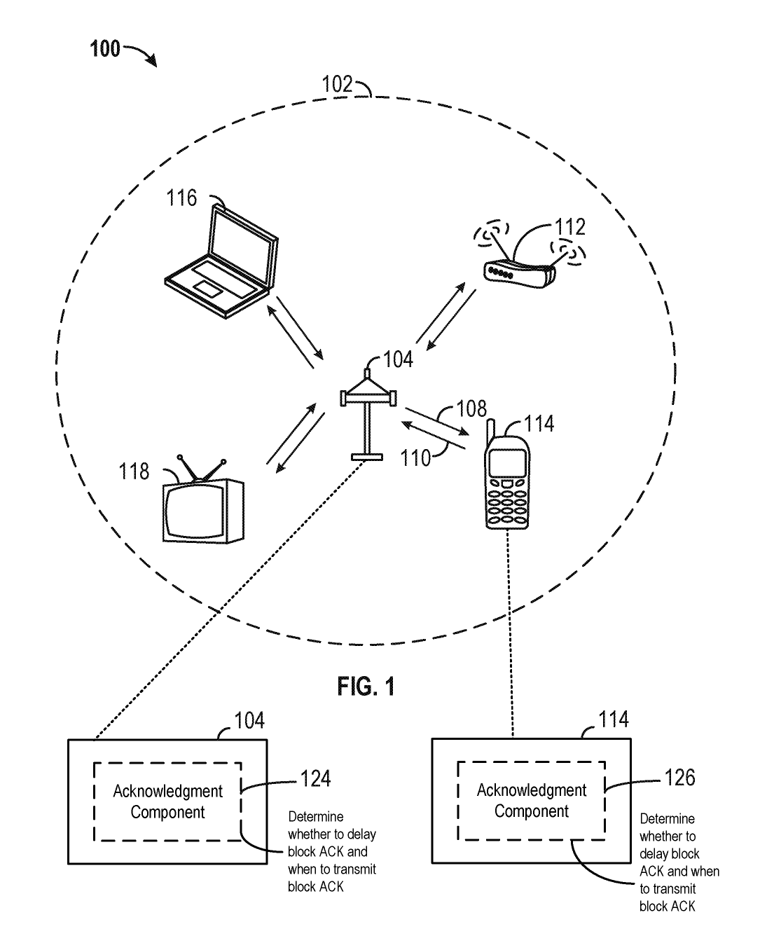

FIG. 1 shows an example wireless communication system 100 in which aspects of the present disclosure may be employed. The wireless communication system 100 may operate pursuant to a wireless standard, for example the 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may increase suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions. In one example, the AP 104 may include an acknowledgment component 124 configured to configure a first communication protocol layer of the AP 104 for a no acknowledgment (NoACK) policy. The acknowledgment component 124 may be configured to prepare a first packet and a second packet to transmit to a second wireless device. The first packet may include a first acknowledgment (ACK) policy indicator within a control header of the first packet requesting a delayed ACK or a scheduled ACK in response to the first packet. The second packet may include a second ACK policy indicator within a control header of the second packet requesting a delayed ACK or a scheduled ACK in response to the second packet. The acknowledgment component 124 may be configured to transmit the first packet and a second packet to the second wireless device. The acknowledgment component 124 may be configured to receive a third packet and determine that the third packet comprises a delayed ACK or a scheduled ACK based on the first ACK policy indicator and the second ACK policy indicator.

In another example, the acknowledgment component 124 may be configured to configure a first communication protocol layer of the AP 104 for a NoACK policy. The acknowledgment component 124 may be configured to receive a first packet from a first wireless device and determine that the first packet includes a first ACK policy indicator within a control header of the first packet requesting a delayed ACK in response to the first packet. For example, the first ACK policy indicator may be included in a control field of a MAC header of the first packet. The acknowledgment component 124 may be configured to receive a second packet from the first wireless device. The acknowledgment component 124 may be configured to determine that the second packet includes a second ACK policy indicator within a control header of the second packet requesting a delayed ACK in response to the second packet. For example, the second ACK policy indicator may be included in a control field of a MAC header of the second packet. The acknowledgment component 124 may be configured to determine a time to transmit the delayed ACK associated with the first packet and the second packet based on the first ACK policy indicator and the second ACK policy indicator. The acknowledgment component 124 may be configured to prepare a third packet to transmit to the first wireless device, the third packet comprising the delayed ACK based on the first ACK policy indicator and the second ACK policy indicator. The acknowledgment component 124 may be configured to transmit the third packet at the determined time.

In another aspect, the STA 114 may include one or more components for performing various functions. In one example, the STA 114 may include an acknowledgment component 126 that performs the same functions as the acknowledgment component 124, described supra.

In a Wi-Fi network, wireless devices such as APs and STAs may use various protocols (e.g., enhanced distributed channel access (EDCA) protocols) to manage wireless traffic. Wireless protocols such as the EDCA protocol may control traffic using a set of parameters: CWMIN (contention window minimum), CWMAX (contention window maximum), AIFSN (arbitration interframe space number), and TXOP (transmit opportunity). In an aspect, CWMIN, the minimum contention window, determines the random amount of time a wireless device (e.g., a STA) may need to back off before the wireless device may transmit data. The random backoff is chosen randomly between 0 and the contention window value. The minimum value the contention window can take is CWMIN. In an aspect, the CWMIN may be similar to a counter. A larger CWMIN value means the wireless device needs to back off (or count) for a longer period of time before attempting to transmit data.

After the backoff period has passed, the wireless device may attempt to transmit data. If the transmission fails, the wireless device may increase the CWMIN value by a factor of 2 (e.g., CWMIN*2). The wireless device may wait for a random time between 0 and CWMIN*2 and attempt to transmit the data again. If the transmission fails again, the wireless device may increase the CWMIN value by another factor of 2 (e.g., CWMIN*4). If the re-transmission fails again, the CWMIN will be further doubled until the new CWMIN value is greater than or equal to CWMAX, at which point CWMIN does not exceed CWMAX (and CWMIN may be set to CWMAX). AIFSN, which stands for arbitration interframe space number, may represent a fixed back off duration that occurs before the random back off. As such, a smaller AIFSN represents a smaller fixed back off. TXOP, or transmit opportunity, represents the data/data packet duration. A longer TXOP increases the air time for data transmission, which enables more data to be transmitted.

The aforementioned parameters, such as TXOP, may be important in dense wireless networks. For example, if TXOP is set too low, traffic data throughout may diminish because wireless devices may not have sufficient time to transmit data. If TXOP is set too high, some wireless devices may be starved for time to transmit.

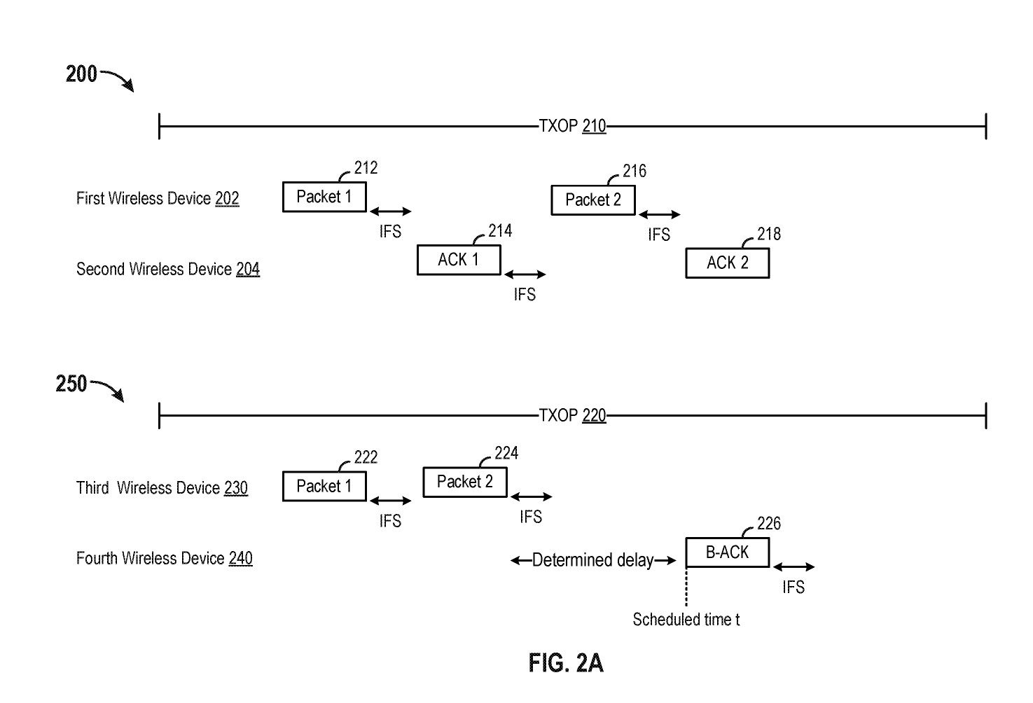

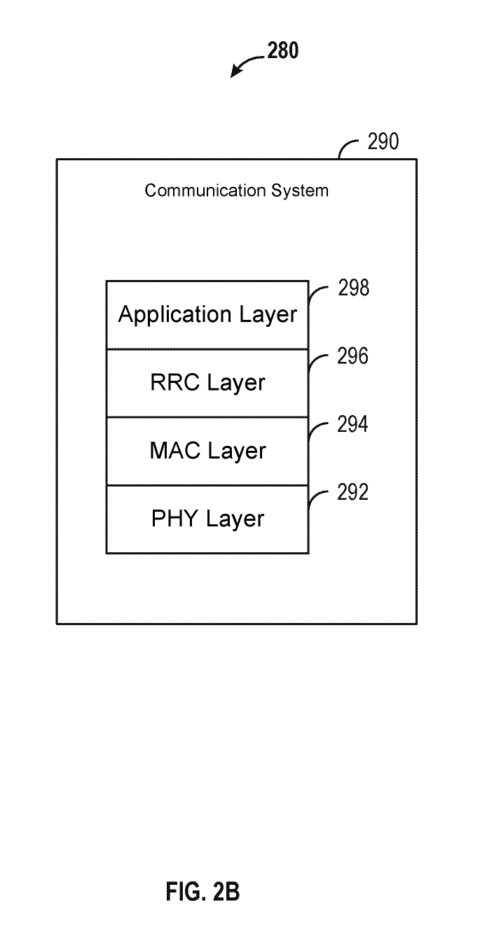

FIG. 2A illustrates exemplary diagrams 200, 250 of methods for controlling acknowledgment responses to frame transmissions. Referring to diagram 200, a first wireless device 202 may have data to transmit to a second wireless device 204 within a TXOP 210. The first wireless device 202 may transmit a first packet 212 (or frame) to the second wireless device 204. The second wireless device 204 may receive the first packet 212, and after an interfame space (IFS), such as a short interframe space (SIFS) or any other kind of IFS, the second wireless device may transmit a first ACK 214 to the first wireless device 202. The first ACK 214 may acknowledge the reception of the first packet 212. Subsequently, the first wireless device 202 may transmit a second packet 216 within the TXOP 210. The second wireless device 204 may receive the second packet 216, and after an IFS, transmit a second ACK 218.

In diagram 200, the second wireless device 204 may be obligated to transmit an ACK after each received packet. As a background, wireless devices use communication protocols for controlling the reception and transmission of communications. Examples of these communication protocols may include the Universal Mobile Telecommunications System (UMTS) protocol or Long Term Service (LTS) protocols. The communication protocols may use communication functions for controlling how a packet is received and what type of response is needed when a packet is received. FIG. 2B illustrates a conceptual model 280 used by wireless communication devices. The conceptual model 280 is based on the Open Systems Interconnection model (OSI model) and is used to characterize basic communication systems used by a wireless device. As shown a communication system 290 may include a physical (PHY) layer 292, a data link layer 294, a network layer 296, and an application layer 298. The communication system 290 may include additional layers, however, a description of additional layers is not provided for brevity. Each of the layers of the communication system 290 may be implemented differently depending on the protocol used, however a general description of the layers 292-298 is provided below.

The PHY layer 292 may include the electrical components and physical specifications used by a device for communication processes. The data link layer 294 is a layer configured for enable transferring data between devices. The data link layer 294 may include hardware and software to implement processes for providing addressing and channel access control mechanisms to allow a device to communicate with other devices. The data link layer 294 may include a Medium Access Control (MAC) layer, which is configured to controlling the flow of data in out of a device including prioritizing channels. The network layer 296 is a layer configured to transfer packets between devices. The network layer 296 may include a radio resource control (RRC) layer for establishing connections between devices. The application layer 298 is a layer used for interacting with the end user and also interacts with communication components. Typically, the application layer 298 is software installed on top of firmware. For many applications the PHY layer 292 and the at least portions of the data link layer 294 (e.g., the MAC layer) are integrated together in a system-on-chip (SOC) implementation.

In diagram 200, the hardware layer of the second wireless device 204 may be obligated to transmit an ACK because the hardware layer is configured for an ACK policy, which requires the transmission of an ACK in response to a received packet. An example of the hardware layer may include the PHY layer. Delaying the ACK transmission may be beneficial in some instances. For example, a transmitter device may want to transmit packets to multiple destinations. If the transmitter device receives ACK responses after an IFS from all the destination devices at the same time, the respective ACK responses from the various devices may interfere with one another causing the transmitter device to not receive all ACK transmissions. For example, if a transmitting device transmits DL packets A1 and A2 to multiple devices B1 and B2, the transmission of A1 and A2 may occur at different times. For example, the transmission of A1 may be completed before the transmission of A2. B1 will then respond with an ACK on an UL while A2 is being transmitted on a DL. Since the UL and the DL are on the same frequency, interference may occur between the UL and DL. As such, a need exists to delay or stagger ACK transmissions to reduce interference.

In other words, Wi-Fi may provide multiple ACK mechanisms (e.g., immediate ACK, immediate BlockACK, etc.). Due to the nature of carrier sense multiple access (CSMA) protocol and other Wi-Fi MAC specifics, the ACK mechanisms are usually implemented in hardware, such as the PHY layer, and therefore, do not allow for a flexible scheduling of ACKs which may be required for time division multiplex-based protocols. As such, a need exists for a NoACK policy for Wi-Fi packets that require a scheduled transmission of an ACK (e.g., a TDM slot, etc.) and a way to implement a delayed or a scheduled block ACK in firmware or software such that a receiving device may ignore or repurpose the NoACK bit in the packets and schedule a block ACK at an appropriate time. A software or firmware solution may avoid hardware inflexibility and allow flexible frame timing.

Referring to diagram 250, a third wireless device 230 and the fourth wireless device 240 may have a schedule for transmitting data packets and receiving ACKs in response to the transmitted data packets. In an aspect, the schedule may be a time-division multiplexed set of time slots within a TXOP 220. The schedule may include a first subset of slots reserved for the third wireless device 230 to transmit data packets and a second subset of slots reserved for the fourth wireless device 240 to transmit ACKs. Further, the schedule may include a third subset of slots reserved for the fourth wireless device 240 to transmit data packets, and a fourth subset of slots reserved for the third wireless device 230 to transmit ACKs. In one aspect, the schedule may be pre-negotiated between the third wireless device 230 and the fourth wireless device 240. In another aspect, the schedule may be received from a network entity (e.g., a network server or any other wireless device).

Referring to the diagram 250, first communication protocol layers for the third wireless device 230 and the fourth wireless device 240 may be configured for a NoACK policy. The first communication protocol layers may include hardware layers such as the PHY layers for the third wireless device 230 and the fourth wireless device 240. A second communication protocol layer for the third wireless device 230 may prepare a first packet 222 and a second packet 224 to include ACK policy indicators that are unknown or ignored by the first communication protocol layers of the third wireless device 230 and the fourth wireless device 240. The second communication protocol layer may include a communication protocol layer or software layer (e.g., the RRC layer) higher than the MAC layer. The third wireless device 230 may transmit the first packet 222 to the fourth wireless device 240. After an IFS, the third wireless device 230 may transmit the second packet 224 to the fourth wireless device. The first packet 222 may include a first ACK policy indicator that indicates whether an ACK associated with the first packet 222 should be delayed or sent according to the schedule. The first ACK policy indicator may be provided within a control header (e.g., a MAC header) of the first packet 222. Similarly, the second packet 224 may include a second ACK policy indicator that indicates whether an ACK associated with the second packet 224 should be delayed or sent according to the schedule. In an aspect, the first and second ACK policy indicator may be set to a value (e.g., using one or more bits) indicating that the ACK should be delayed or send according to a schedule.

After the fourth wireless device 240 receives the first and second packets 222, 224, the first communication protocol layer (e.g., the PHY layer) of the fourth wireless device 240 may treat the first and second packets 222, 224 as NoACK packets and therefore pass each of the received packets to a second communication protocol layer (e.g., a communication protocol layer higher than the MAC layer such as an RRC layer) of the fourth wireless device 240. The second communication protocol layer (e.g., a layer higher than the MAC layer such as an RRC layer) for the fourth wireless device 240 may extract the first and second ACK policy indicators. Because both of the ACK policy indicators indicate a request to delay the ACK transmission, the fourth wireless device 240 may delay the ACK transmission. The fourth wireless device 240 may accumulate the acknowledgment information associated with the third and fourth packets 222, 224 into a third packet 226. The third packet 226 may include a block ACK (B-ACK). In one configuration, the fourth wireless device 240 may determine a time for transmitting the third packet 226. In an aspect, the delay for transmitting the third packet 226 may be preconfigured, such as a fixed offset time of fixed number of time slots. In one example, the fourth wireless device 240 may delay transmitting the third packet 226 by some time (e.g., 100 ms) or some number of time slots (e.g., 3 time slots) after receiving the first packet 222 or a last packet in a sequence of packets from the third wireless device 230. In another example, the fourth wireless device 240 may transmit the third packet 226 some predetermined time before the end of the TXOP 220. In another configuration, the fourth wireless device 240 may determine a next available or last available time slot reserved for transmitting an ACK and transmit the third packet 226 during the time slot. In another example, the time for transmitting the third packet 226 may be a function of an identifier of the fourth wireless device 240.

While in the above examples the fourth wireless device 240 has been described as transmitting a third packet including an ACK or B-ACK, the present application is not limited to these aspects, as one skilled in the art would recognize that the third packet may include a negative ACK (NACK) and the B-ACK may include one or more ACKs or NACKs.

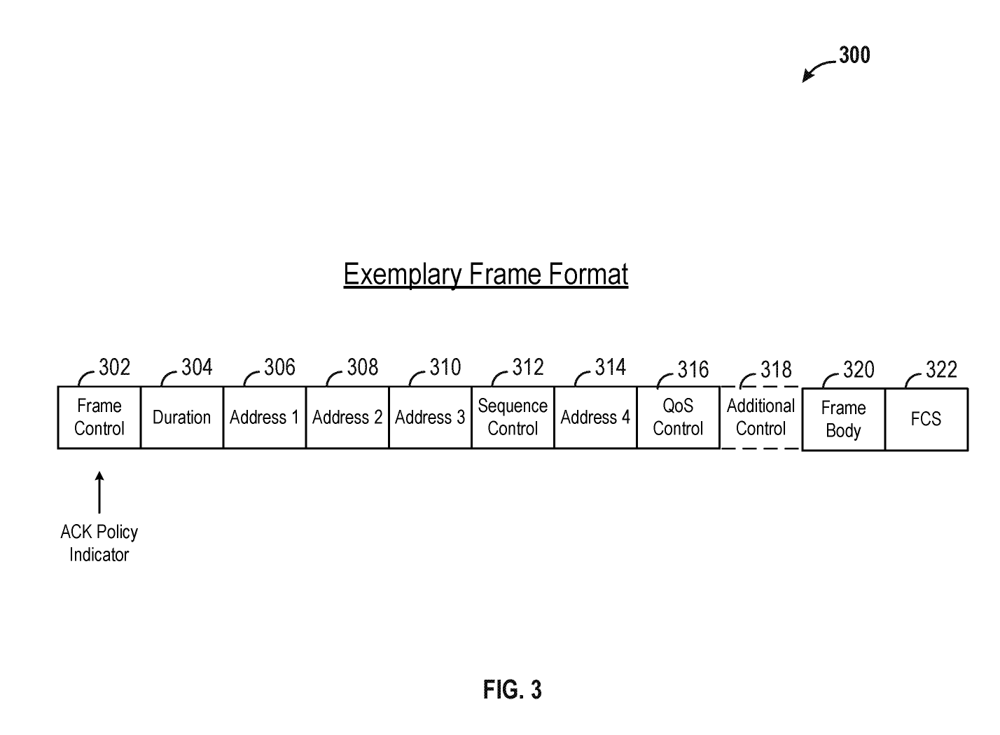

FIG. 3 illustrates an exemplary diagram of a frame 300 with an ACK policy indicator. Referring to FIG. 3, the frame 300 may include a frame control field 302, a duration field 304, a first address field 306, a second address field 308, a third address field 310, a sequence control field 312, a fourth address field 314, a quality of service (QoS) control field (316), an additional control field 318, a frame body 320, and a frame check sequence (FCS) field 322. The frame control field 302 may include subfields related to control information for the frame 300. The ACK policy indicator may include one or more bits and may be included in one or more of the fields in the frame 300. For example, the ACK policy indicator may be included within the frame control field 302. In an aspect, the frame control field 302 may include a subtype subfield, which may include the ACK policy indicator (e.g., a value of 1110 in the subtype subfield may indicate a request for a delayed or scheduled ACK transmission). In other examples, the ACK policy indicator may be included in one of the additional control field 318 or the frame body field 320. The foregoing frame structure for the frame 300 is exemplary, and other frame structures may also be used.

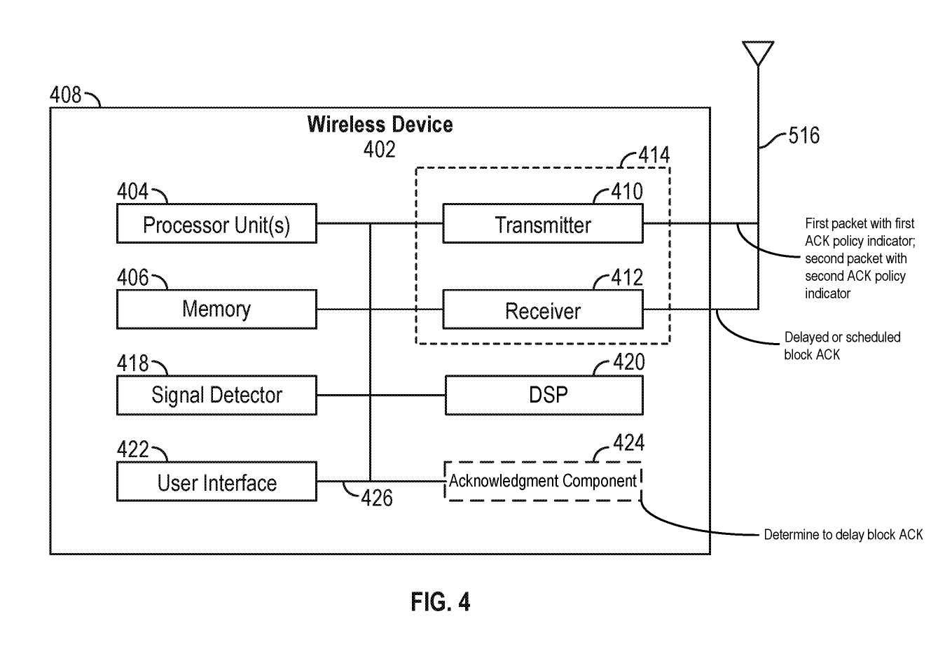

FIG. 4 is a functional block diagram of a wireless device 402 that may be employed within the wireless communication system 100 of FIG. 1. The wireless device 402 is an example of a device that may be configured to implement the various methods described herein. For example, the wireless device 402 may be the AP 104 or the STA 114.

The wireless device 402 may include a processor 404 which controls operation of the wireless device 402. The processor 404 may also be referred to as a central processing unit (CPU). Memory 406, which may include both read-only memory (ROM) and random access memory (RAM), may provide instructions and data to the processor 404. A portion of the memory 406 may also include non-volatile random access memory (NVRAM). The processor 404 may perform logical and arithmetic operations based on program instructions stored within the memory 406. The instructions in the memory 406 may be executable (by the processor 404, for example) to implement the methods described herein.

The processor 404 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 402 may also include a housing 408, and the wireless device 402 may include a transmitter 410 and/or a receiver 412 to allow transmission and reception of data between the wireless device 402 and a remote device. The transmitter 410 and the receiver 412 may be combined into a transceiver 414. An antenna 416 may be attached to the housing 408 and electrically coupled to the transceiver 414. The wireless device 402 may also include multiple transmitters, multiple receivers, multiple transceivers, and/or multiple antennas.

The wireless device 402 may also include a signal detector 418 that may be used to detect and quantify the level of signals received by the transceiver 414 or the receiver 412. The signal detector 418 may detect such signals as total energy, energy per subcarrier per symbol, power spectral density, and other signals. The wireless device 402 may also include a DSP 420 for use in processing signals. The DSP 420 may be configured to generate a packet for transmission. In some aspects, the packet may comprise a physical layer convergence protocol (PLCP) protocol data unit (PPDU).

The wireless device 402 may further comprise a user interface 422 in some aspects. The user interface 422 may comprise a keypad, a microphone, a speaker, and/or a display. The user interface 422 may include any element or component that conveys information to a user of the wireless device 402 and/or receives input from the user. The wireless device 402 may also comprise an acknowledgment component 424. In one configuration, the acknowledgment component 424 may be configured to prepare a first packet (e.g., 222) to transmit to a second wireless device (e.g., fourth wireless device 240). The first packet may include an ACK policy indicator requesting ACK/NACK feedback associated with the first packet to be delayed longer than an expected ACK/NACK response time period T1 in response to the first packet. For example, the acknowledgment component 424 may prepare a control field (e.g., 302) of the first packet to include bits (e.g., 1110) to indicate a delayed ACK response is requested. The acknowledgment component 424 may also be configured to transmit, to the second wireless device, the first packet including the ACK policy indicator requesting the ACK/NACK feedback to be delayed. The acknowledgment component 424 may further be configured to receive a second packet (e.g., 226) from the second wireless device in response to the transmitted first packet. The second packet may be received after a time period T2, where the time period T2 may be greater than the time period T1. In an example, the time period T1 may be the IFS after the first packet 222 and the time period T2 may be the determined delay time, as shown by FIG. 2. The acknowledgment component 424 may also be configured to determine that the second packet comprises a delayed ACK/NACK providing ACK/NACK feedback to the transmitted first packet based on the ACK policy indicator.

In some aspects, the acknowledgment component 424 may transmit, to the second wireless device, a third packet (e.g., 224) including a second ACK policy indicator requesting a second delayed ACK/NACK. The second ACK policy indicator may request ACK/NACK feedback associated with the third packet to be delayed longer than an expected ACK/NACK response time period T3 (e.g., the IFS after packet 224) in response to the third packet. The second packet may be received in response to the transmitted first packet and the third packet. Further, the time period T2 may be greater than the time period T1 and greater than the time period T3. For example, as shown by FIG. 2A, the packet 226 may be received after the determined delay in which both packet 222 and packet 224 have been received and the IFSs of both packets 222, 224 have passed. In some examples the time period T3 may be may be preconfigured, such as a fixed offset time of fixed number of time slots, as described above. In some examples, the time period T1 and the time period T3 may be the same (e.g., the IFS time for the packets 222, 224). Further, the second packet may include the delayed ACK/NACK and the second delayed ACK/NACK to provide the ACK/NACK feedback associated with the first packet and the ACK/NACK feedback associated with third packet based on the ACK policy indicator and the second ACK policy indicator.

In some aspects, the acknowledgment component 424 may signal in a control header of the first packet that the ACK policy indicator is in the first packet. For example, as shown by FIG. 3, the acknowledgment component 424 may prepare a control field (e.g., 302) of a MAC header of an 802.11 packet 300 to include predetermined bits (e.g., 1110) to signal that the ACK policy indicator is in the first packet. In an example, the predetermined bits may be the ACK policy indicator. In an example, a control header of the second packet includes signaling that the delayed ACK/NACK is in the second packet.

In some aspects, the acknowledgment component 424 may further configure the wireless device 402 for a NoACK policy. Further, the first packet may be prepared after the wireless device 402 is configured for the NoACK policy. In some aspects, the wireless device 402 may be configured for the NoACK policy by a first communication protocol layer (e.g., the PHY layer) of the wireless device 402. In some aspects, the first packet may be prepared and the second packet may be determined to comprise the delayed ACK/NACK by a second communication protocol layer (e.g., the RRC layer) of the wireless device 402.

The various components of the wireless device 402 may be coupled together by a bus system 426. The bus system 426 may include a data bus, for example, as well as a power bus, a control signal bus, and a status signal bus in addition to the data bus. Components of the wireless device 402 may be coupled together or accept or provide inputs to each other using some other mechanism.

Although a number of separate components are illustrated in FIG. 4, one or more of the components may be combined or commonly implemented. For example, the processor 404 may be used to implement not only the functionality described above with respect to the processor 404, but also to implement the functionality described above with respect to the signal detector 418, the DSP 420, the user interface 422, and/or the acknowledgment component 424. Further, each of the components illustrated in FIG. 4 may be implemented using a plurality of separate elements.

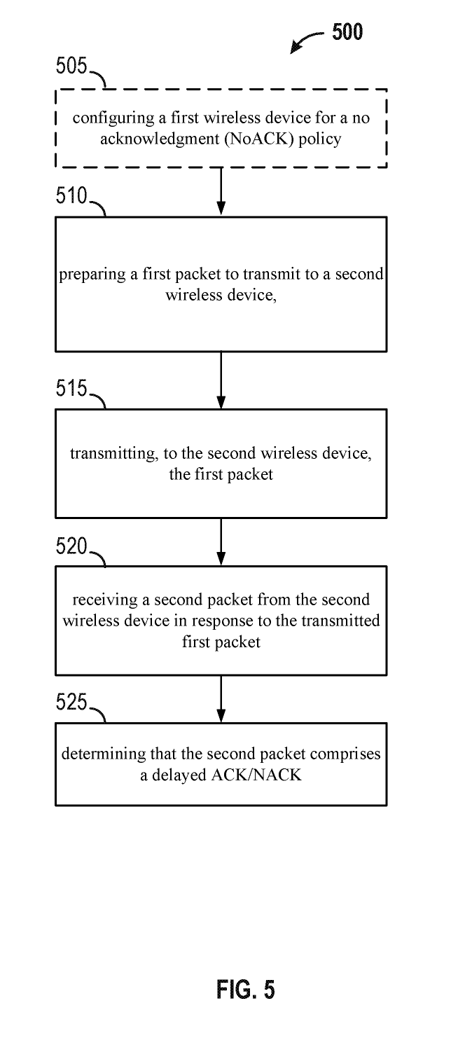

FIG. 5 is a flowchart of an exemplary method 500 of wireless communication for controlling acknowledgment frames. The method 500 may be performed using an apparatus (e.g., the STA 114, the AP 104, or the wireless device 402, for example). Although the method 500 is described below with respect to the elements of wireless device 402 of FIG. 4, other components may be used to implement one or more of the blocks described herein. As shown in FIG. 5, blocks with dotted lines represent optional operations.

At block 505, a hardware layer for the apparatus may be configured for a NoACK policy. In some aspects, the apparatus may be configured for the NoACK policy by a first communication protocol layer (e.g., the PHY layer) of the apparatus.

At block 510, the apparatus may prepare a first packet to transmit to a second wireless device. The first packet may be prepared by a second communication protocol layer (e.g., the RRC layer) after the first communication protocol layer configures the NoACK policy. The first packet may include an ACK policy indicator requesting ACK/NACK feedback to be delayed longer than an expected ACK/NACK response time period T1 (e.g., the IFS following 222) in response to the first packet. For example, as shown by FIG. 3, the apparatus may prepare a control field (e.g., 302) of a MAC header of an 802.11 packet 300 to include the ACK policy indicator. The control field may include predetermined bits (e.g., 1110) that are set to indicate an ACK policy indicator that requests a delayed ACK or scheduled ACK. The control header may be configured by a second communication protocol layer (e.g., the RRC layer) above the first communication protocol layer, and, because the first communication protocol layer is configured under a NoACK policy, ignores any ACK policy indicators in the control header.

At block 515, the apparatus may transmit, to a second wireless device, the first packet including the first ACK policy indicator requesting the ACK/NACK feedback to be delayed. For example, as described above, the third wireless device 230 may transmit the first packet 222 to the fourth wireless device 240.

At block 520, the apparatus may receive a second packet (e.g., 226) from the second wireless device (e.g., 240) in response to the transmitted first packet (e.g., 222). The second packet (e.g., 226) may be received after a time period T2 (e.g., the determined delay time), the time period T2 being greater than the time period T1.

At block 525, the apparatus may determine, by the second communication protocol layer (e.g., RRC layer 296), that the second packet comprises a delayed ACK/NACK providing ACK/NACK feedback to the transmitted first packet based on the ACK policy indicator. In an example, the second communication protocol layer may determine that the third packet includes the delayed ACK by checking a control header of the third packet and determining that the control header includes a set of bits set to a predetermined bit value (e.g., 1110) that indicates that the packet is a delayed ACK. In an aspect, the apparatus may also determine which packets correspond to the delayed ACK. For example, the apparatus may check either the control field or another field such as an additional control field (e.g., 318), a sequence control field (e.g., 312), or a frame body field (e.g., 320) for the indication.

In some aspects, the ACK policy indicator may be signaled in a control header (e.g., 302) of the first packet (e.g., 222) and the delayed ACK/NACK is signaled in a control header (e.g., 302) of the second packet (e.g., 226).

In some aspects, the apparatus may transmit, to the second wireless device (e.g., 240), a third packet (224) including a second ACK policy indicator requesting a second delayed ACK/NACK. The third packet (e.g., 224) may include the second ACK policy indicator requesting ACK/NACK feedback to be delayed longer than an expected ACK/NACK response time period T3 (e.g., IFS following 224) in response to the third packet. In some aspects, the second ACK policy indicator may be signaled within a control header of the third packet. Further, in some aspects the apparatus may receive the second packet (e.g., 226) in response to the transmitted first packet (e.g., 222) and the third packet (e.g., 224). Further, the time period T2 may be greater than the time period T1 (e.g., IFS following 222) and greater than the time period T3 (e.g., IFS following 224). In some aspects, the second packet (226) may include the delayed ACK/NACK and the second delayed ACK/NACK to provide ACK/NACK feedback to the transmitted first packet (e.g., 222) and the transmitted third packet (e.g., 224) based on the ACK policy indicator and the second ACK policy indicator.

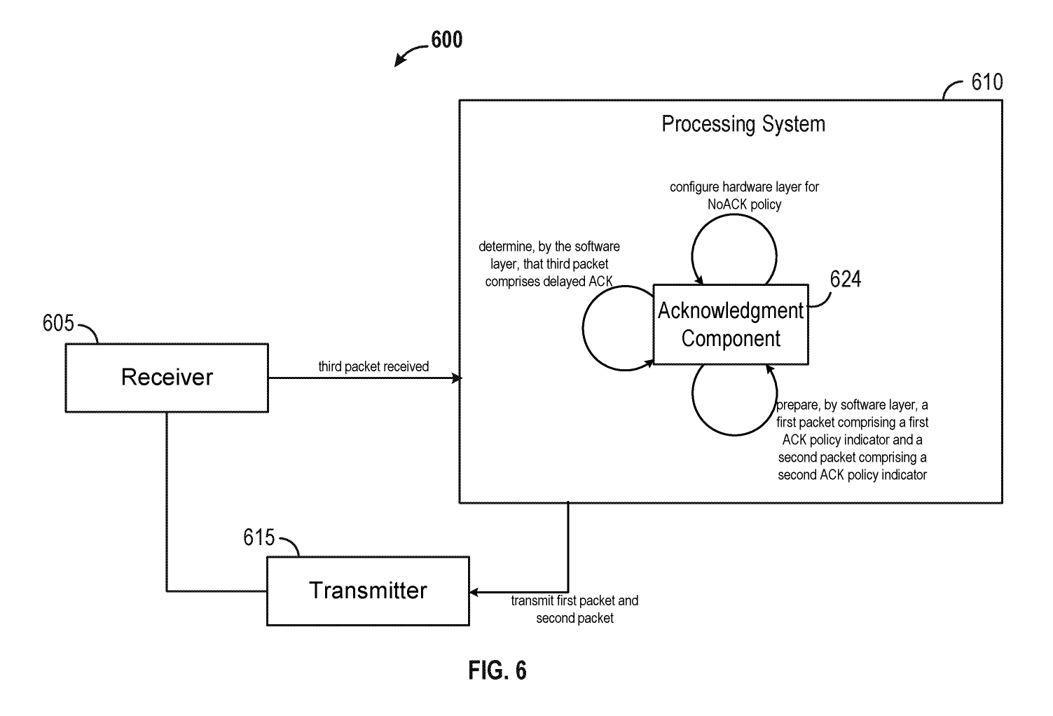

FIG. 6 is a functional block diagram of an exemplary wireless communication device 600 that controls acknowledgment frames. The wireless communication device 600 may include a receiver 605, a processing system 610, and a transmitter 615. The processing system 610 may include an acknowledgment component 624 configured to perform the various functions described herein.

The receiver 605, the processing system 610, the acknowledgment component 624, and/or the transmitter 615 may be configured to perform one or more functions discussed above with respect to blocks 505-525, of FIG. 5. The receiver 605 may correspond to the receiver 412. The processing system 610 may correspond to the processor 404. The transmitter 615 may correspond to the transmitter 410. The acknowledgment component 624 may correspond to the acknowledgment component 124 and/or the acknowledgment component 424.

In one configuration, the wireless communication device 600 may include means for performing the various functions described herein. In an example, the wireless communication device 600 includes means for configuring a first communication protocol layer (e.g., a hardware layer such as the PHY layer) of the apparatus for a no acknowledgment (NoACK) policy. The wireless communication device 600 may further include means for preparing a first packet to transmit to a second wireless device. The first packet may include a first acknowledgment (ACK) policy indicator within a control header of the first packet requesting a delayed ACK in response to the first packet. The wireless communication device 600 may further include means for transmitting the first packet to the second wireless device. The wireless communication device 600 may also include means for receiving a second packet from the second wireless device in response to the transmitted first packet. The wireless communication device 600 may further include means for determining that the second packet comprises a delayed ACK/NACK providing ACK/NACK feedback to the transmitted first packet based on the ACK policy indicator. The aforementioned means may be one or more of the aforementioned components of the UE 402, the receiver 605, the processing system 610, or the transmitter 615 configured to perform the functions recited by the aforementioned means.

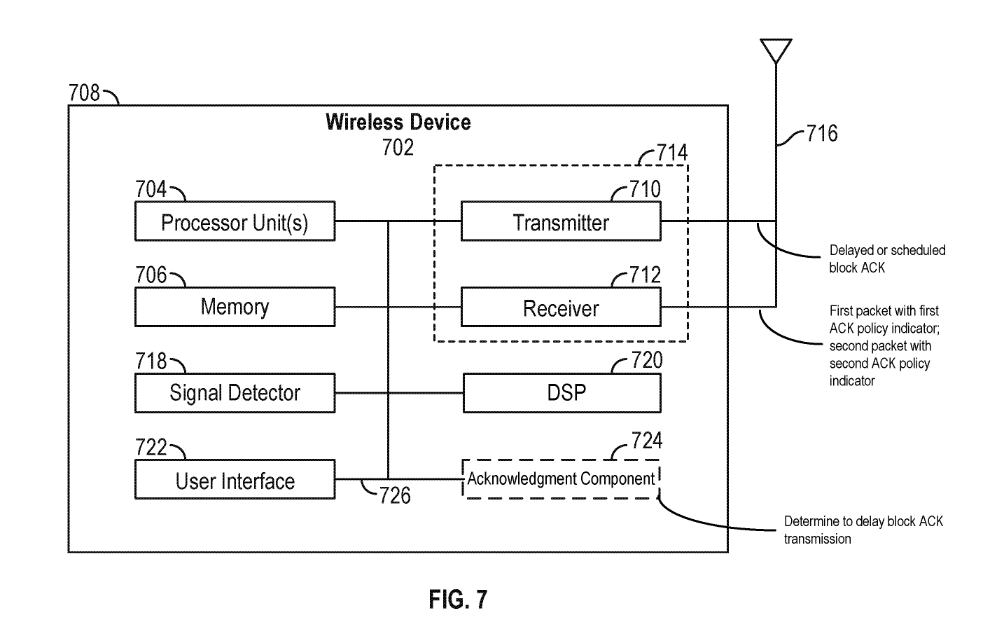

FIG. 7 is a functional block diagram of a wireless device 702 that may be employed within the wireless communication system 100 of FIG. 1. The wireless device 702 is an example of a device that may be configured to implement the various methods described herein. For example, the wireless device 702 may be the AP 104 or the STA 114.

The wireless device 702 may include a processor 704 which controls operation of the wireless device 702. The processor 704 may also be referred to as a CPU. Memory 706, which may include both ROM and RAM, may provide instructions and data to the processor 704. A portion of the memory 706 may also include NVRAM. The processor 704 may perform logical and arithmetic operations based on program instructions stored within the memory 706. The instructions in the memory 706 may be executable (by the processor 704, for example) to implement the methods described herein.

The processor 704 may include or be a component of a processing system implemented with one or more processors. The one or more processors may be implemented with any combination of general-purpose microprocessors, microcontrollers, DSPs, FPGAs, PLDs, controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 702 may also include a housing 708, and the wireless device 702 may include a transmitter 710 and/or a receiver 712 to allow transmission and reception of data between the wireless device 702 and a remote device. The transmitter 710 and the receiver 712 may be combined into a transceiver 714. An antenna 716 may be attached to the housing 708 and electrically coupled to the transceiver 714. The wireless device 702 may also include multiple transmitters, multiple receivers, multiple transceivers, and/or multiple antennas.

The wireless device 702 may also include a signal detector 718 that may be used to detect and quantify the level of signals received by the transceiver 714 or the receiver 712. The signal detector 718 may detect such signals as total energy, energy per subcarrier per symbol, power spectral density, and other signals. The wireless device 702 may also include a DSP 720 for use in processing signals. The DSP 720 may be configured to generate a packet for transmission. In some aspects, the packet may comprise a PPDU.

In some aspects, the wireless device 702 may further include a user interface 722. The user interface 722 may include a keypad, a microphone, a speaker, and/or a display. The user interface 722 may include any element or component that conveys information to a user of the wireless device 702 and/or receives input from the user. The wireless device 702 may also include an acknowledgment component 724. In one configuration, the acknowledgment component 724 may be configured to configure the wireless device 702 for a NoACK policy. In an example, the acknowledgment component 724 may configure a first communication protocol layer (e.g., a hardware layer such as the PHY layer) of the wireless device 702 for a NoACK policy. For example, the acknowledgment component 724 may configure the first communication protocol layer under the NoACK policy, to not transmit an ACK in response to incoming packets. The acknowledgment component 724 may be configured to receive a first packet from a second wireless device. The first packet may include an ACK policy indicator requesting ACK/NACK feedback associated with the first packet to be delayed longer than an expected ACK/NACK response time period T1 in response to the first packet. For example, the expected response time period T1 may be the IFS after packet 222.

The acknowledgment component 724 may determine that the first packet includes the ACK policy indicator. For example, the acknowledgment component 724 may check a control field (e.g., 302) of a MAC header of an 802.11 packet (e.g., 300) to determine whether the first packet includes the first ACK policy indicator. In an example, the control field may include a set of bits set to a predetermined bit value (e.g., 1110) to indicate an ACK policy indicator that requests a delayed ACK or scheduled ACK. In some aspects, the MAC header may be configured by a second communication protocol layer (e.g., the RRC layer) above the first communication protocol layer.

The acknowledgment component 724 may determine a time period T2 to transmit the ACK/NACK feedback associated with the first packet based on the ACK policy indicator. In an example, the time period T2 may be greater than the time period T1. In an aspect, the acknowledgment component 724 may determine the time period T2, or a delayed time for transmitting the delayed ACK, based on a preconfigured time, such as a fixed offset time or a fixed number of time slots. In one example, the acknowledgment component 724 may determine a delayed time for transmitting the delayed ACK based on a predetermined time (e.g., 100 ms) or a predetermined number of time slots (e.g., 3 time slots) after receiving the first packet or a last packet in a sequence of packets. For example, the acknowledgment component 724 may start a timer after receiving the first packet, and delay ACKs in response to the first packet and all subsequent packets received during the predetermined time. In another example, the acknowledgment component 724 may determine a delayed time for transmitting the delayed ACK based on a predetermined time before the end of a TXOP. For example, the acknowledgment component 724 may determine an end time of the TXOP and calculate a predetermined time before the end time of the TXOP. The acknowledgment component 724 may then delay ACKs in response to all packets received up to the predetermine time before the end time of the TXOP and then transmit an ACK or block ACK after the predetermined time and before the end of the TXOP. In another configuration, the acknowledgment component 724 may determine a delayed time for transmitting the delayed ACK based on a next available or last available time slot reserved for transmitting an ACK and transmit a packet including the delayed ACK during the time slot. For example, after having received a packet having an ACK policy indicator, the acknowledgment component 724 may check when a next time slot is available and delay ACKs in response to the first packet and all subsequent packets having ACK policy indicators that are received prior to the next available time slot. The acknowledgment component 724 may then transmit the third packet having the delayed ACK during the next available time slot and delay a next ACK based on a next set of packets having ACK policy indicators. In another example, the acknowledgment component 724 may determine a delayed time for transmitting the delayed ACK based on a function of an identifier of the wireless device 702. For example, the acknowledgment component 724 may determine the identifier for the wireless device 702 and, based on the identifier, determine a scheduled time or scheduled time slots that the wireless device 702 has pre-configured to communicate with the first wireless device.

The acknowledgment component 724 may prepare a second packet to transmit to the second wireless device. The second packet may include a delayed ACK/NACK providing the ACK/NACK feedback associated with the first packet based on the ACK policy indicator. For example, the acknowledgment component 724 may prepare a control field of the third packet to include bits (e.g., 1110) to indicate that the third packet includes one or more delayed ACKs. The control field, or another field, may also include bits (e.g., 0001 and 0010) to identify the packets (e.g., the first and second packets) the delayed ACK is acknowledging. For example, the sequence control field 312, the additional control field 318, or the frame body field 320 may include the bits to identify the packets the delayed ACK is acknowledging. Once the time period T2 is determined, the acknowledgment component 724 may transmit the second packet comprising the delayed ACK/NACK at the determined time period T2.

The various components of the wireless device 702 may be coupled together by a bus system 726. The bus system 726 may include a data bus, for example, as well as a power bus, a control signal bus, and a status signal bus in addition to the data bus. Components of the wireless device 702 may be coupled together or accept or provide inputs to each other using some other mechanism.

Although a number of separate components are illustrated in FIG. 7, one or more of the components may be combined or commonly implemented. For example, the processor 704 may be used to implement not only the functionality described above with respect to the processor 704, but also to implement the functionality described above with respect to the signal detector 718, the DSP 720, the user interface 722, and/or the acknowledgment component 724. Further, each of the components illustrated in FIG. 7 may be implemented using a plurality of separate elements.

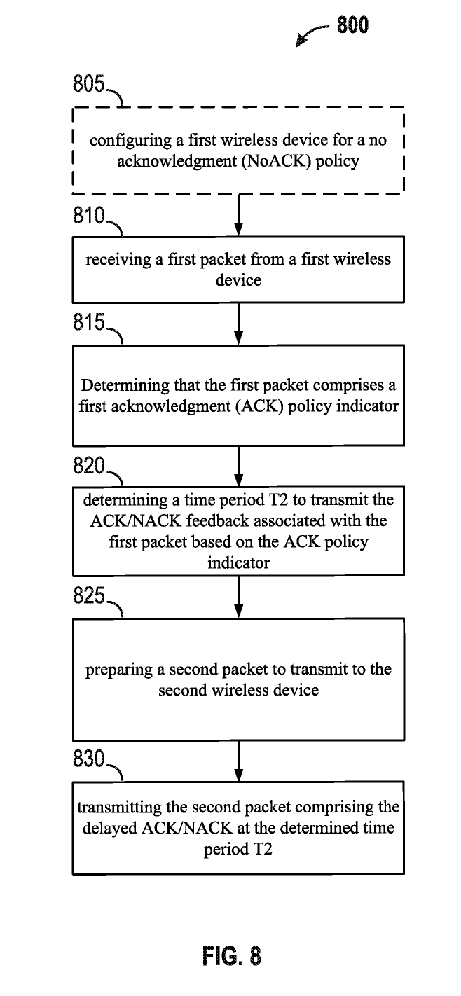

FIG. 8 is a flowchart of an example method 800 of wireless communication for controlling acknowledgment frames. The method 800 may be performed using an apparatus (e.g., the STA 114, or the wireless device 702, for example). Although the method 800 is described below with respect to the elements of wireless device 702 of FIG. 7, other components may be used to implement one or more of the blocks described herein. In an aspect, blocks with dotted lines indicate an optional operation.

At block 805, the apparatus may configure a hardware layer for a NoACK policy. For example, a first communication protocol layer (e.g., PHY layer) of the apparatus may configure the apparatus for a NoACK policy. For example, the apparatus may configure the hardware layer under the NoACK policy, to not transmit an ACK in response to incoming packets.

At block 810, the apparatus may receive a first packet from a second wireless device. The first packet may include an ACK policy indicator requesting ACK/NACK feedback associated with the first packet to be delayed longer than an expected ACK/NACK response time period T1 in response to the first packet. For example, the ACK policy indicator may request that ACK/NACK feedback be delayed a predetermined time, or at scheduled time, as discussed above.

At block 815, the apparatus may determining that the first packet includes the ACK policy indicator. For example, the apparatus may determine that a control field (e.g., 302) of a MAC header of an 802.11 packet (e.g., 300) includes the first ACK policy indicator. For example, the control field may include a set of bits set to a predetermined bit value (e.g., 1110) to indicate an ACK policy indicator is requesting a delayed ACK or a scheduled ACK. In an example, the control header may decoded/read by a second communication protocol layer (e.g., the RRC layer) above the first communication protocol layer. Further, because the first communication protocol layer is configured under the NoACK policy, the first communication protocol layer ignores the first ACK policy indicator, or the control header, and passes the first packet to a higher layer without sending an ACK in response to receiving the first packet.

At block 820, the apparatus may determine a time period T2 to transmit the ACK/NACK feedback associated with the first packet based on the ACK policy indicator. The time period T2 may be greater than the time period T1. In an aspect, the apparatus may determine the time period T2, or a delayed time for transmitting the delayed ACK, based on a preconfigured time, such as a fixed offset time or a fixed number of time slots. In one example, the apparatus may determine a delayed time for transmitting the delayed ACK based on a predetermined time (e.g., 100 ms) or a predetermined number of time slots (e.g., 3 time slots) after receiving the first packet or a last packet in a sequence of packets. For example, the apparatus may start a timer after receiving the first packet, and delay ACKs in response to the first packet and all subsequent packets received during the predetermined time. In another example, the apparatus may determine a delayed time for transmitting the delayed ACK based on a predetermined time before the end of a TXOP. For example, the apparatus may determine an end time of the TXOP and calculate a predetermined time before the end time of the TXOP. The apparatus may then delay ACKs in response to all packets received up to the predetermine time before the end time of the TXOP and then transmit an ACK or block ACK after the predetermined time and before the end of the TXOP. In another configuration, the apparatus may determine a delayed time for transmitting the delayed ACK based on a next available or last available time slot reserved for transmitting an ACK and transmit a packet including the delayed ACK during the time slot. For example, after having received a packet having an ACK policy indicator, the apparatus may check when a next time slot is available and delay ACKs in response to the first packet and all subsequent packets having ACK policy indicators that are received prior to the next available time slot. In this case, the apparatus may schedule to transmit a second packet having the delayed ACK by avoiding conflicts with an IFS.

At block 825, the apparatus may prepare a second packet to transmit to the second wireless device. The second packet may include a delayed ACK/NACK providing the ACK/NACK feedback associated with the first packet based on the ACK policy indicator. In some aspects, the apparatus may signal in a control header of the second packet that the second packet includes the delayed ACK/NACK. For example, the apparatus may prepare a control field of the second packet to include bits (e.g., 1110) to indicate that the second packet includes a delayed ACK(s) and further include bits to (e.g., 0001 or 0011) to identify the packets (e.g., the first packet or third packet) being acknowledged by the delayed ACK.

At block 830, the apparatus may transmitting the second packet including the delayed ACK/NACK at the determined time period T2.

In aspects, the apparatus may receive additional packets. For example, the apparatus may receive a third packet having a second ACK policy indicator requesting ACK/NACK feedback associated with the third packet to be delayed longer than an expected response time period T3. For example, the apparatus may receive the packet 224 and the time period T3 may by the IFS after the packet 224. Further, the apparatus may prepare the second packet to further include the ACK/NACK feedback associated with the third packet based on the second ACK policy indicator. Thus, in this example, the second packet may be a B-ACK. The apparatus may also determine the time period T2 further based on the second policy indicator received from the second wireless device. The time period T2 may be greater than the time period T1 and the time period T3. For example, as shown by FIG. 2A, the packet 226 may be received after the determined delay in which both packet 222 and packet 224 have been received and the IFSs of both packets 222, 224 have passed. In some examples the time period T3 may be may be preconfigured, such as a fixed offset time of fixed number of time slots, as described above. In some examples, the time period T1 and the time period T3 may be the same (e.g., the IFS time for the packets 222, 224).

In some aspects, the apparatus may determine the time period T2 to transmit the ACK/NACK feedback associated with the first packet by determining when to transmit the ACK/NACK feedback in a scheduled uplink resource to reduce uplink and downlink interference.

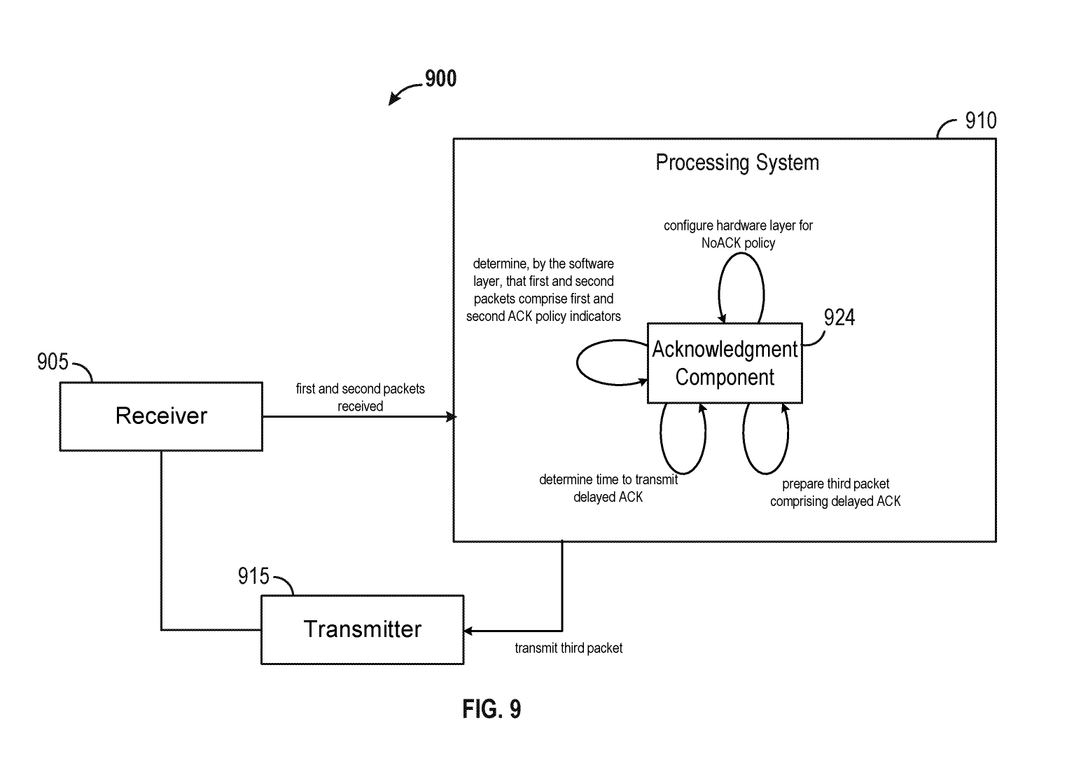

FIG. 9 is a functional block diagram of an exemplary wireless communication device 900. The wireless communication device 900 may include a receiver 905, a processing system 910, and a transmitter 915. The processing system 910 may include an acknowledgment component 924 that may be configured to performed the various functions recited herein.

The receiver 905, the processing system 910, the acknowledgment component 924, and/or the transmitter 915 may be configured to perform one or more functions discussed above with respect to blocks 805-840 of FIG. 8. The receiver 905 may correspond to the receiver 712. The processing system 910 may correspond to the processor 704. The transmitter 915 may correspond to the transmitter 710. The acknowledgment component 924 may correspond to the acknowledgment component 126 and/or the acknowledgment component 724.

In one configuration, the wireless communication device 900 may include means for performing the various functions recited herein. In an example, the wireless communication device 900 may include means for configuring a first communication protocol layer of the apparatus for a no acknowledgment (NoACK) policy. The wireless communication device 900 may further include means for receiving, from a second wireless device, a first packet including ACK policy indicator requesting ACK/NACK feedback associated with the first packet to be delayed longer than an expected ACK/NACK response time period T1 in response to the first packet. The wireless communication device 900 may further include means for means for determining that the first packet comprises the ACK policy indicator. The wireless communication device 900 may further include means for determining a time period T2 to transmit the ACK/NACK feedback associated with the first packet based on the ACK policy indicator. The time period T2 may be greater than the time period T1. The wireless communication device 900 may further include means for preparing a second packet to transmit to the second wireless device. The second packet may include a delayed ACK/NACK providing the ACK/NACK feedback associated with the first packet based on the ACK policy indicator. The wireless communication device 900 may further include means for transmitting the second packet comprising the delayed ACK/NACK at the determined time period T2.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an ASIC, an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein comprise one or more operations or actions for achieving the described method. The method blocks and/or actions may be interchanged with one another without departing from the scope of the claims. In other words, unless a specific order of blocks or actions is specified, the order and/or use of specific blocks and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for.”

What is claimed is:

1. A method of wireless communication by a first wireless device, comprising:
preparing a first packet to transmit to a second wireless device, the first packet comprising an acknowledgment (ACK) policy indicator requesting ACK/negative ACK (NACK) feedback associated with the first packet to be delayed longer than an expected ACK/NACK response time period T1 in response to the first packet;
transmitting, to the second wireless device, the first packet including the ACK policy indicator requesting the ACK/NACK feedback to be delayed;
receiving a second packet from the second wireless device in response to the transmitted first packet, the second packet being received after a time period T2, the time period T2 being greater than the time period T1; and
determining that the second packet comprises a delayed ACK/NACK providing ACK/NACK feedback to the transmitted first packet based on the ACK policy indicator.

2. The method of claim 1, further comprising:
transmitting, to the second wireless device, a third packet including a second ACK policy indicator requesting a second delayed ACK/NACK, the second ACK policy indicator requesting ACK/NACK feedback associated with the third packet to be delayed longer than an expected ACK/NACK response time period T3 in response to the third packet,
wherein the second packet is received in response to the transmitted first packet and the third packet, the time period T2 being greater than the time period T1 and greater than the time period T3,
wherein the second packet comprises the delayed ACK/NACK and the second delayed ACK/NACK to provide the ACK/NACK feedback associated with the first packet and the ACK/NACK feedback associated with third packet based on the ACK policy indicator and the second ACK policy indicator.

3. The method of claim 1, further comprising signaling in a control header of the first packet that the ACK policy indicator is in the first packet, wherein a control header of the second packet includes signaling that the delayed ACK/NACK is in the second packet.

4. The method of claim 1, further comprising:
configuring the first wireless device for a no acknowledgment (NoACK) policy,
wherein the first packet is prepared after the first wireless device is configured for the NoACK policy.

5. The method of claim 4, wherein the first wireless device is configured for the NoACK policy by a first communication protocol layer of the first wireless device.

6. The method of claim 5, wherein the first packet is prepared and the second packet is determined to comprise the delayed ACK/NACK by a second communication protocol layer of the first wireless device.

7. A method of wireless communication by a first wireless device, comprising:
receiving, from a second wireless device, a first packet including an acknowledgment (ACK) policy indicator requesting ACK/negative ACK (NACK) feedback associated with the first packet to be delayed longer than an expected ACK/NACK response time period T1 in response to the first packet;
determining that the first packet comprises the ACK policy indicator;
determining a time period T2 to transmit the ACK/NACK feedback associated with the first packet based on the ACK policy indicator, the time period T2 being greater than the time period T1;
preparing a second packet to transmit to the second wireless device, the second packet comprising a delayed ACK/NACK providing the ACK/NACK feedback associated with the first packet based on the ACK policy indicator; and
transmitting the second packet comprising the delayed ACK/NACK at the determined time period T2.

8. The method of claim 7, further comprising:
receiving a third packet having a second ACK policy indicator requesting ACK/NACK feedback associated with the third packet to be delayed longer than an expected response time period T3,
wherein the second packet is prepared to further comprise the ACK/NACK feedback associated with the third packet based on the second ACK policy indicator,
wherein the determining the time period T2 is further based on the second policy indicator received from the second wireless device, the time period T2 being greater than the time period T1 and the time period T3.

9. The method of claim 7, wherein the determining the time period T2 to transmit the ACK/NACK feedback associated with the first packet includes determining when to transmit the ACK/NACK feedback in a scheduled uplink resource to reduce uplink and downlink interference.

10. The method of claim 7, further comprising signaling in a control header of the second packet that the second packet includes the delayed ACK/NACK, wherein a control header of the first packet includes the ACK policy indicator.

11. The method of claim 7, wherein the time period T2 is determined further based on a fixed offset time or a fixed number of time slots.

12. The method of claim 7, further comprising:
configuring the first wireless device for a no acknowledgment (NoACK) policy,
wherein the first packet is determined to comprise the ACK policy indicator, after the first wireless device is configured for the NoACK policy.

13. The method of claim 12, wherein the first wireless device is configured for the NoACK policy by a first communication protocol layer of the first wireless device.

14. The method of claim 13, wherein the first packet is determined to comprise the ACK policy indicator and the second packet is prepared by a second communication protocol layer of the first wireless device.

15. An apparatus for wireless communication, comprising:
means for preparing a first packet to transmit to a second wireless device, the first packet comprising an acknowledgment (ACK) policy indicator requesting ACK/negative ACK (NACK) feedback associated with the first packet to be delayed longer than an expected ACK/NACK response time period T1 in response to the first packet;
means for transmitting, to the second wireless device, the first packet including the ACK policy indicator requesting the ACK/NACK feedback to be delayed;
means for receiving a second packet from the second wireless device in response to the transmitted first packet, the second packet being received after a time period T2, the time period T2 being greater than the time period T1; and
means for determining that the second packet comprises a delayed ACK/NACK providing ACK/NACK feedback to the transmitted first packet based on the ACK policy indicator.

16. The apparatus of claim 15, further comprising:
means for transmitting, to the second wireless device, a third packet including a second ACK policy indicator requesting a second delayed ACK/NACK, the second ACK policy indicator requesting ACK/NACK feedback associated with the third packet to be delayed longer than an expected ACK/NACK response time period T3 in response to the third packet,
wherein the second packet is received in response to the transmitted first packet and the third packet, the time period T2 being greater than the time period T1 and greater than the time period T3,
wherein the second packet comprises the delayed ACK/NACK and the second delayed ACK/NACK to provide the ACK/NACK feedback associated with the first packet and the ACK/NACK feedback associated with third packet based on the ACK policy indicator and the second ACK policy indicator.

17. The apparatus of claim 15, further comprising means for signaling in a control header of the first packet that the ACK policy indicator is in the first packet, wherein a control header of the second packet includes signaling that the delayed ACK/NACK is in the second packet.

18. The apparatus of claim 15, further comprising:
means for configuring the apparatus for a no acknowledgment (NoACK) policy,
wherein the first packet is prepared after the apparatus is configured for the NoACK policy.

19. The apparatus of claim 18, wherein the apparatus is configured for the NoACK policy by a first communication protocol layer of the apparatus.

20. The apparatus of claim 19, wherein the first packet is prepared and the second packet is determined to comprise the delayed ACK/NACK by a second communication protocol layer of the apparatus.

21. An apparatus for wireless communication, comprising:
means for receiving, from a second wireless device, a first packet including an acknowledgment (ACK) policy indicator requesting ACK/negative ACK (NACK) feedback associated with the first packet to be delayed longer than an expected ACK/NACK response time period T1 in response to the first packet;
means for determining that the first packet comprises the ACK policy indicator;
means for determining a time period T2 to transmit the ACK/NACK feedback associated with the first packet based on the ACK policy indicator, the time period T2 being greater than the time period T1;
means for preparing a second packet to transmit to the second wireless device, the second packet comprising a delayed ACK/NACK providing the ACK/NACK feedback associated with the first packet based on the ACK policy indicator; and
means for transmitting the second packet comprising the delayed ACK/NACK at the determined time period T2.

22. The apparatus of claim 21, further comprising:
means for receiving a third packet having a second ACK policy indicator requesting ACK/NACK feedback associated with the third packet to be delayed longer than an expected response time period T3,
wherein the second packet is prepared to further comprise the ACK/NACK feedback associated with the third packet based on the second ACK policy indicator,
wherein the determining the time period T2 is further based on the second policy indicator received from the second wireless device, the time period T2 being greater than the time period T1 and the time period T3.

23. The apparatus of claim 21, wherein the means for determining the time period T2 to transmit the ACK/NACK feedback associated with the first packet includes means for determining when to transmit the ACK/NACK feedback in a scheduled uplink resource to reduce uplink and downlink interference.

24. The apparatus of claim 21, further comprising means for signaling in a control header of the second packet that the second packet includes the delayed ACK/NACK, wherein a control header of the first packet includes the ACK policy indicator.

25. The apparatus of claim 21, wherein the time period T2 is determined further based on a fixed offset time or a fixed number of time slots.

26. The apparatus of claim 21, further comprising:
means for configuring the apparatus for a no acknowledgment (NoACK) policy,
wherein the first packet is determined to comprise the ACK policy indicator, after the apparatus is configured for the NoACK policy.

27. The apparatus of claim 26, wherein the apparatus is configured for the NoACK policy by a first communication protocol layer of the apparatus.

28. The apparatus of claim 27, wherein the first packet is determined to comprise the ACK policy indicator and the second packet is prepared by a second communication protocol layer of the apparatus.

29. An apparatus for wireless communication, comprising:
a memory; and
at least one processor coupled to the memory and configured to:
prepare a first packet to transmit to a second wireless device, the first packet comprising an acknowledgment (ACK) policy indicator requesting ACK/negative ACK (NACK) feedback associated with the first packet to be delayed longer than an expected ACK/NACK response time period T1 in response to the first packet;
transmit, to the second wireless device, the first packet including the ACK policy indicator requesting the ACK/NACK feedback to be delayed;
receive a second packet from the second wireless device in response to the transmitted first packet, the second packet being received after a time period T2, the time period T2 being greater than the time period T1; and
determine that the second packet comprises a delayed ACK/NACK providing ACK/NACK feedback to the transmitted first packet based on the ACK policy indicator.

30. The apparatus of claim 29, wherein the at least one processor is further configured to:
transmit, to the second wireless device, a third packet including a second ACK policy indicator requesting a second delayed ACK/NACK, the second ACK policy indicator requesting ACK/NACK feedback associated with the third packet to be delayed longer than an expected ACK/NACK response time period T3 in response to the third packet,
wherein the second packet is received in response to the transmitted first packet and the third packet, the time period T2 being greater than the time period T1 and greater than the time period T3,
wherein the second packet comprises the delayed ACK/NACK and the second delayed ACK/NACK to provide the ACK/NACK feedback associated with the first packet and the ACK/NACK feedback associated with third packet based on the ACK policy indicator and the second ACK policy indicator.

31. The apparatus of claim 29, wherein the at least one processor is further configured to signal in a control header of the first packet that the ACK policy indicator is in the first packet, wherein a control header of the second packet includes signaling that the delayed ACK/NACK is in the second packet.

32. The apparatus of claim 29, wherein the at least one processor is further configured to:
configure the apparatus for a no acknowledgment (NoACK) policy,
wherein the first packet is prepared after the apparatus is configured for the NoACK policy.

33. The apparatus of claim 32, wherein the apparatus is configured for the NoACK policy by a first communication protocol layer of the apparatus.

34. The apparatus of claim 33, wherein the first packet is prepared and the second packet is determined to comprise the delayed ACK/NACK by a second communication protocol layer of the apparatus.

35. An apparatus for wireless communication, comprising:
a memory; and
at least one processor coupled to the memory and configured to:
receive, from a second wireless device, a first packet including an acknowledgment (ACK) policy indicator requesting ACK/negative ACK (NACK) feedback associated with the first packet to be delayed longer than an expected ACK/NACK response time period T1 in response to the first packet;
determine that the first packet comprises the ACK policy indicator;
determine a time period T2 to transmit the ACK/NACK feedback associated with the first packet based on the ACK policy indicator, the time period T2 being greater than the time period T1;
prepare a second packet to transmit to the second wireless device, the second packet comprising a delayed ACK/NACK providing the ACK/NACK feedback associated with the first packet based on the ACK policy indicator; and
transmit the second packet comprising the delayed ACK/NACK at the determined time period T2.

36. The apparatus of claim 35, wherein the at least one processor is further configured to:
receive a third packet having a second ACK policy indicator requesting ACK/NACK feedback associated with the third packet to be delayed longer than an expected response time period T3,
wherein the second packet is prepared to further comprise the ACK/NACK feedback associated with the third packet based on the second ACK policy indicator,
wherein the determining the time period T2 is further based on the second policy indicator received from the second wireless device, the time period T2 being greater than the time period T1 and the time period T3.

37. The apparatus of claim 35, wherein the at least one processor is further configured to determine when to transmit the ACK/NACK feedback in a scheduled uplink resource to reduce uplink and downlink interference.

38. The apparatus of claim 35, wherein the at least one processor is further configured to signal in a control header of the second packet that the second packet includes the delayed ACK/NACK, wherein a control header of the first packet includes the ACK policy indicator.

39. The apparatus of claim 35, wherein the time period T2 is determined further based on a fixed offset time or a fixed number of time slots.

40. The apparatus of claim 35, wherein the at least one processor is further configured to:
configure the apparatus for a no acknowledgment (NoACK) policy,
wherein the first packet is determined to comprise the ACK policy indicator, after the apparatus is configured for the NoACK policy.

41. The apparatus of claim 40, wherein the apparatus is configured for the NoACK policy by a first communication protocol layer of the apparatus.

42. The apparatus of claim 41, wherein the first packet is determined to comprise the ACK policy indicator and the second packet is prepared by a second communication protocol layer of the apparatus.

43. A computer-readable medium storing computer executable code for an apparatus, comprising code for:
preparing a first packet to transmit to a second wireless device, the first packet comprising an acknowledgment (ACK) policy indicator requesting ACK/negative ACK (NACK) feedback associated with the first packet to be delayed longer than an expected ACK/NACK response time period T1 in response to the first packet;
transmitting, to the second wireless device, the first packet including the ACK policy indicator requesting the ACK/NACK feedback to be delayed;
receiving a second packet from the second wireless device in response to the transmitted first packet, the second packet being received after a time period T2, the time period T2 being greater than the time period T1; and
determining that the second packet comprises a delayed ACK/NACK providing ACK/NACK feedback to the transmitted first packet based on the ACK policy indicator.

44. The computer-readable medium of claim 43, further comprising code for:
transmitting, to the second wireless device, a third packet including a second ACK policy indicator requesting a second delayed ACK/NACK, the second ACK policy indicator requesting ACK/NACK feedback associated with the third packet to be delayed longer than an expected ACK/NACK response time period T3 in response to the third packet,
wherein the second packet is received in response to the transmitted first packet and the third packet, the time period T2 being greater than the time period T1 and greater than the time period T3,
wherein the second packet comprises the delayed ACK/NACK and the second delayed ACK/NACK to provide the ACK/NACK feedback associated with the first packet and the ACK/NACK feedback associated with third packet based on the ACK policy indicator and the second ACK policy indicator.

45. The computer-readable medium of claim 43, further comprising code for signaling in a control header of the first packet that the ACK policy indicator is in the first packet, wherein a control header of the second packet includes signaling that the delayed ACK/NACK is in the second packet.

46. The computer-readable medium of claim 43, further comprising code for:
configuring the apparatus for a no acknowledgment (NoACK) policy,
wherein the first packet is prepared after the apparatus is configured for the NoACK policy.

47. The computer-readable medium of claim 46, wherein the apparatus is configured for the NoACK policy by a first communication protocol layer of the apparatus.

48. The computer-readable medium of claim 47, wherein the first packet is prepared and the second packet is determined to comprise the delayed ACK/NACK by a second communication protocol layer of the apparatus.

49. A computer-readable medium storing computer executable code for a first wireless device, comprising code for:
receiving, from a second wireless device, a first packet including an acknowledgment (ACK) policy indicator requesting ACK/negative ACK (NACK) feedback associated with the first packet to be delayed longer than an expected ACK/NACK response time period T1 in response to the first packet;
determining that the first packet comprises the ACK policy indicator;
determining a time period T2 to transmit the ACK/NACK feedback associated with the first packet based on the ACK policy indicator, the time period T2 being greater than the time period T1;
preparing a second packet to transmit to the second wireless device, the second packet comprising a delayed ACK/NACK providing the ACK/NACK feedback associated with the first packet based on the ACK policy indicator; and
transmitting the second packet comprising the delayed ACK/NACK at the determined time period T2.

50. The computer-readable medium of claim 49, further comprising code for:
receiving a third packet having a second ACK policy indicator requesting ACK/NACK feedback associated with the third packet to be delayed longer than an expected response time period T3,
wherein the second packet is prepared to further comprise the ACK/NACK feedback associated with the third packet based on the second ACK policy indicator,
wherein the determining the time period T2 is further based on the second policy indicator received from the second wireless device, the time period T2 being greater than the time period T1 and the time period T3.

51. The computer-readable medium of claim 49, further comprising code for: determining when to transmit the ACK/NACK feedback in a scheduled uplink resource to reduce uplink and downlink interference.

52. The computer-readable medium of claim 49, further comprising code for signaling in a control header of the second packet that the second packet includes the delayed ACK/NACK, wherein a control header of the first packet includes the ACK policy indicator.

53. The computer-readable medium of claim 49, wherein the time period T2 is determined further based on a fixed offset time or a fixed number of time slots.

54. The computer-readable medium of claim 49, further comprising code for:
configuring the first wireless device for a no acknowledgment (NoACK) policy,
wherein the first packet is determined to comprise the ACK policy indicator, after the first wireless device is configured for the NoACK policy.

55. The computer-readable medium of claim 54, wherein the first wireless device is configured for the NoACK policy by a first communication protocol layer of the first wireless device.

56. The computer-readable medium of claim 55, wherein the first packet is determined to comprise the ACK policy indicator and the second packet is prepared by a second communication protocol layer of the first wireless device.
